(19) United States
(12) Patent Application Publication
(10) Pub. No.: US 2007/0067198 A1
(43) Pub. Date: Mar. 22, 2007

(54) Method for fostering participant engagement in a structured environment

(76) Inventor: R. Alex Eggleston, Huntersville, NC (US)

Correspondence Address: NELSON MULLINS RILEY & SCARBOROUGH, LLP, 1320 MAIN STREET, 17TH FLOOR, COLUMBIA, SC, 29201, US

(21) Appl. No.: 11/215,556

(22) Filed: Aug. 30, 2005

(51) Int. Cl. G06F 11/34

(52) U.S. Cl. 705/9; 705/11

(57) ABSTRACT

The invention is a method of fostering engagement in an organization's efforts to meet stated objectives. The method includes identifying objectives to be met, identifying activities that will aid the organization in meeting the stated objectives, and assigning point values to the activities. The method further includes determining a number of teams to participate in the method, assigning members to each team from among the participants in the organization, and conducting a competition for a predetermined amount of time among the teams, wherein each team is awarded points based on the team's success in completing the identified activities.

### BACKGROUND OF THE INVENTION

The invention relates to the field of business relations. More specifically, the invention relates to encouraging participant engagement in an organization.

A common problem in structured environments, such as corporations or hospitals, is an atmosphere wherein the participants, or employees, are disengaged. For example, participants often believe their input in decisions affecting the organization is unimportant or unwanted. Conversely, the management of such organizations often believes the participants in the organization do not take an interest in advancing the goals and objectives of the organization but are, instead, only interested in “putting in their time.” This lack of vertical communication and interaction between the management and the participants in an organization often results in poor organizational morale, as well as poor relations between the management and participants.

Moreover, organizations are often organized into separate divisions, shifts, or work-groups. These divisions are typically rigid barriers formed by the business structure. When there is little or no interaction among these divisions, horizontal communication can suffer within the organization. A lack of horizontal communication can result in confusion and competition between the groups. Such confusion and competition is often counterproductive, and can result in reduced productivity in the organization as a whole, and can also result in a reduction of the bottom-line benefits to the company. Moreover, unwanted competition may further contribute to poor organizational morale.

Poor communication and interaction, whether horizontal or vertical, may also lead to problems such as an unsafe work environment. For example, participants who feel undervalued may believe that the report of a safety problem will go unheeded. As a result, even though the problem may be noticed by one or more individuals, the problem will go unreported. This unreported problem may then worsen until an accident resulting in injury occurs.

Similarly, when poor horizontal communication and interaction is a problem within an organization, resentments between divisions may fester. Such resentments may lead to lower productivity, with different divisions reluctant to work together to overcome problems in the processes of the organization.

As a further result of poor horizontal communication and interaction, once a lack of cooperation, communication, and interaction between divisions becomes a problem, this lack may be perceived as intentional and may result in an environment where resentment builds between divisions to the point where it is almost impossible to overcome. For example, the failure of a first division to report an issue, such as a safety hazard, to a second division may result in an injury within the second division. This failure to report an issue, therefore, may create an “us against them” attitude among the divisions, resulting in additional counterproductive competition.

It is often difficult for an organization to encourage horizontal communication and interaction when the size of the organization and the rigid barriers of the organization's division structure make it difficult for the participants to communicate and interact across the division barriers. Participants in a first division of the organization may begin to feel isolated from participants in a different division of the organization due to the presence of these inherent structural barriers. Additionally, the structural barriers make it possible for participants to “hide” from involvement and engagement.

Moreover, it is difficult for the organization to encourage vertical communication and interaction when the management and other participants in the organization have an uncomfortable relationship due to past problems.

Organizations have attempted to overcome these problems by encouraging participant involvement and communication, both horizontally and vertically. While it is often relatively easy to get participants in an organization “involved” in meeting the objectives of the organization, it is more difficult to get the employees “engaged” in the process. Participants who are merely “involved” in meeting the objectives of the organization are those that will show up for meetings and events where they are seen attending, but do not take an active, individual role in the organization's progress in meeting its objectives. “Engaged” participants, however, are those who take a proactive role in furthering an organization's efforts in meeting objectives. Engaged participants are those who willingly assume leadership roles and encourage other participants to become engaged.

Additionally, it is often difficult to maintain a high level of participant involvement over a period of time. Often, when a new initiative is introduced, participants will become excited and get involved. As time passes, the newness of the initiative may wear off, resulting in decreased involvement.

### SUMMARY OF THE INVENTION

Accordingly, in one aspect the invention is a method of fostering engagement in an organization's efforts to meet stated objectives. The method includes identifying objectives to be met, identifying activities that will aid the organization in meeting the stated objectives, and assigning point values to the activities. The method further includes determining a number of teams to participate in the method, assigning members to each team from among the participants in the organization, and conducting a competition for a predetermined amount of time among the teams, wherein each team is awarded points based on the team's success in completing the identified activities.

In another aspect, the invention is a team-based competitive method for fostering participant engagement in an organization. The method includes dividing participants in the organization into a predetermined number of teams and conducting a competition among the teams for a predetermined period of time. As a part of the competition, the method also includes awarding points to each team for completing a series of activities aimed at helping the organization achieve predetermined objectives. The method further includes conducting the competition according to the format of an athletic season.

In yet another aspect, the invention is a method of improving communication among the divisions of an organization. The method includes creating teams, wherein each team includes members from different divisions of the organization. The method further includes identifying activities that will aid the organization in achieving improved communication, assigning point values to the identified activities, and conducting a competition between the teams, in which each team is awarded points for completing the identified activities, and wherein the competition is patterned after a sports league.

In another aspect, the invention is an interactive system for fostering participant engagement in an organization's efforts to meet stated objectives. The system includes a platform for organizing and tracking the progress of a method for fostering participant engagement. The method includes identifying objectives to be met within an organization, identifying activities that will aid the organization in meeting the objectives, and assigning point values to the identified activities. The method further includes determining a number of teams to participate, assigning members to each team from among participants in the organization, and conducting a competition among the teams for a predetermined time period, wherein each team is awarded points based on the team's success in completing the identified activities.

The foregoing, as well as other objectives and advantages of the invention and the manner in which the same are accomplished, is further specified within the following detailed description and its accompanying drawings.

### BRIEF DESCRIPTION OF THE DRAWINGS

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements.

FIG. 1 is a representative depiction of a navigational page for a system in accordance with one embodiment of the present invention;

FIG. 2 is a representative depiction of a league setup page for a system in accordance with one embodiment of the present invention;

FIG. 3 is a representative depiction of a division setup page for a system in accordance with one embodiment of the present invention;

FIG. 4 is a representative depiction of a team setup page for a system in accordance with one embodiment of the present invention;

FIG. 5 is a representative depiction of a player selection page for a system in accordance with one embodiment of the present invention;

FIG. 6 is a representative depiction of a standings summary page for a system in accordance with one embodiment of the present invention;

FIG. 7 is a representative depiction of a score sheet template for a system in accordance with one embodiment of the present invention; and

FIG. 8 is a representative depiction of a league summary page for a system in accordance with one embodiment of the present invention.

### DETAILED DESCRIPTION

The invention relates to systems and methods of fostering participant engagement in an organization's efforts to meet stated goals.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

Exemplary organizations that may benefit from utilizing the methods and systems of the present invention include, but are not limited to, schools (including elementary, secondary, and advanced educational institutions), manufacturing organizations, safety organizations, quality organizations, hospitals, clinics, and other healthcare facilities, restaurants, sales focused organizations, and non-profit organizations, as well as other corporations and businesses the could benefit from wide-range engagement of the participants of the organization, e.g. students or employees. Additionally, organizations that may benefit from utilizing the methods and systems of the present invention are those having one or more concerns such as research and development, manufacturing, product development, efficiency, distributorship, sales, safety, quality, and other concerns known to persons having ordinary skill in the art.

This list of representative organizations in which the invention may be utilized is not intended to be exhaustive or limiting. Rather, it is a representative list of organizations that would benefit from the methods and products disclosed and claimed herein. The invention is intended to include other organizations known or recognized by persons having ordinary skill in the art. Additionally, as used herein, the term “organization” is used to describe an organization, such as a corporation, as a whole, as well as smaller organizations, such as a safety organization, within a corporation.

In one aspect, the method of the present invention can include identifying objectives to be met, identifying activities that will aid the organization in meeting those objectives, and assigning point values to the activities. The method further includes determining a number of teams to participate in the method, assigning members to each team from among participants in the organization, and conducting a competition for a predetermined period of time, wherein each team is awarded points based on the team's success in completing the identified activities.

The relevant steps described above and below may be carried out in the order in which they are discussed. Alternatively, the inventive steps may be carried out in a different order. The order in which the steps are conducted may vary depending on the nature of the organization, its needs, and/or the like. Alternating the order of the steps of the method, however, is not required.

In an exemplary embodiment, the inventive method includes identifying desirable objectives for the organization. For example, desirable objectives in a school may include improved grades for the students, more efficient study habits, better time management skills, and/or better relations between faculty and the students.

In a safety organization, desirable objectives may include improved workplace safety and/or improved safety of the products being produced.

In a quality organization, desirable objectives may include improved quality control processes and/or improved quality of the products being produced.

In a hospital or other healthcare facility, desirable objectives may include improved safety of the hospital staff and patients, improved patient satisfaction, and/or improved relations between doctors, nurses, other staff, and administrators.

This list of desired objectives is not intended to be exhaustive or limiting. Rather, it is a list of representative objectives that may be identified. The invention is intended to include other objectives known by persons having ordinary skill in the art, including persons having ordinary skill in the art of the various organizations.

The method can further include identifying activities that may aid the organization in meeting the stated objectives. The activities may be generic to all organizations that would benefit from the invention. For example, the activities may include conducting a team meeting; choosing a team name; attending a team meeting; organizing, facilitating, and conducting a meeting of participants in the organization; suggesting additional objectives or goals; identifying solutions to existing problems; and/or participating in solutions to problems.

Additionally, activities may be specific to a particular organization. For example, a school may identify activities such as holding a study session, turning in homework, participating in community service, and/or taking part in an extracurricular activity such as a club or a sport.

In another embodiment, where the organization is a safety organization, the selected activities may include creating a work-order to repair or replace a safety hazard, a report of unsafe conditions, preparation of a written analysis of safe job procedures, and/or conducting or attending job safety training.

In yet another embodiment, where the organization is a quality organization, identified activities may include identification of non-conformance with standards, conducting or attending quality training, conducting quality inspections, and/or preparation of a written analysis of quality procedures.

The above listing of identified activities is representative and is not intended to be exhaustive or limiting. Other activities known by persons having ordinary skill in the relevant art are also contemplated as suitable for use in accordance with the present method.

The method may be formatted as a competition among teams and may further include determining a number of teams to participate in the competition. The number of teams may be determined based on the size of the organization. The number of teams may also be determined according to the format of the competition. For example, if the competition is to be organized according to the format of a professional football league, it may be desirable to have two leagues, each of which have two divisions, with each division including more than one team. In an exemplary embodiment, a team leader is assigned for each team to guide the team in carrying out the identified activities.

The method can also include assigning members to each team from among the participants in the organization. The team members may be chosen randomly or through a draft format. The team members may be selected by the team leaders, the organizers of the competition, and/or may be chosen by a committee. Additionally, the team members may be assigned by any method known in the art. In an exemplary embodiment, persons from different divisions can be assigned to a single team. Such cross-functional teams encourage horizontal communication and interaction as people from different divisions (e.g., different shifts or different grades) learn to work together and thereby overcome past difficulties.

Additionally, teams may include members from different levels of the organization. Teams including members from different levels of the organization will encourage communication and interaction that will also aid in overcoming past difficulties.

The use of cross-functional teams, which may include members from different divisions and/or levels of an organization, may aid in overcoming the barriers to communication and interaction that exist due to the rigid structural barriers of the organization.

The method can further include assigning point values to the identified activities. In one embodiment, the method may include assigning point values to each activity based on the importance of the activity in aiding the organization in meeting its objectives. The point values for each activity may also be different or equal. Point values may be assigned by persons organizing the method, or may be part of the participants' initial duties (for example, as organized in teams as discussed herein). Additionally point values may be assigned for activities that an individual on the team completes and/or for activities in which the entire team participates.

The method also includes conducting a competition among the teams for a predetermined time period. In an exemplary embodiment, the method includes awarding points to each team based on the team's success (by individuals on the team and/or by the entire team) in completing the identified activities.

The existence of points that can be awarded for an individual's completion of an activity may serve to promote horizontal and vertical communication and interaction within the organization. For example, team members may work together to earn points for the team, but may also encourage one another to complete individual tasks. Such teamwork and camaraderie may also serve to improve communication and interaction within and among the various divisions and levels of an organization.

In an exemplary embodiment, the method includes conducting the competition according to the format of a sports league, such as a professional sports league, a college sports league, and/or an amateur sports league. Sports league formats contemplated as useful in accordance with the present invention include, but are not limited to, professional basketball leagues, professional football leagues, professional hockey leagues, professional baseball leagues, professional soccer leagues, automobile racing leagues, college basketball leagues, college football leagues, college hockey leagues, college baseball leagues, and college soccer leagues. Other sports leagues, such as high school athletic leagues or club leagues, are also contemplated as useful formats for conducting the competition.

Conducting a competition according to the format of a sports league for a predetermined time, such as an athletic season, may aid in sustaining participant engagement. For example, because the season builds to a championship, contributed effort is needed for a team to win. Additionally, because a team may face a different opponent, for example, a different opponent each week, each team has multiple opportunities to “win.”

Additionally, the competition may include awards for individual contributions to the team. For example, awards such as “player-of-the-week,” “player-of-the-month,” “most valuable player,” “most improved,” and “coach-of-the-year” may be awarded at intervals throughout the competition and/or at the end of the competition. The possibility of winning these awards may also serve to encourage sustained engagement.

In one embodiment, the method further includes tracking the competition through the use of a computer-aided system, for example, an internet-based application that automatically updates and posts the progress of the competition is contemplated as useful. In another embodiment, the competition is tracked in a paper format, for example in a league notebook. The competition may also be tracked through the use of a packaged software system. Spreadsheet and presentation software may also be used to track and post the progress of the competition. The method is not limited to web-based, software-based, or notebook based tracking, but may be tracked by any method known to those having ordinary skill in the art. Additionally, the competition may be tracked through the use of a combination of two or more tracking systems.

Additionally, it may be desirable to periodically update and periodically post the standings in the competition to make the participants aware of the progress of the competition.

In another aspect, the invention is a competitive method for fostering participant engagement in an organization. The method includes dividing participants in the organization into a predetermined number of teams and conducting a season-long competition among the teams, wherein each team is awarded points for completing a series of activities aimed at helping the organization achieve predetermined objectives, such as those discussed above and wherein the season-long competition is formatted according to an athletic season, such as those discussed above.

In yet another aspect, the invention is a method of improving horizontal and vertical communication and interaction within an organization. The method includes creating teams including members from different divisions of an organization. The method may further include creating teams including members from different levels of an organization.

In one embodiment, the teams are formed including members from different levels and different divisions of an organization.

The method may also include identifying activities that will aid the organization in achieving improved communication, assigning point values to the identified activities, and conducting a competition between the teams, in which each team is awarded points for completing the identified activities, and wherein the competition is patterned after a sports league.

In an exemplary embodiment, the step of creating teams includes conducting a draft to create teams including members selected from one or both of different divisions and different levels of an organization. These cross-functional teams may serve to overcome the inherent structural barriers (discussed above) that discourage communication and interaction between divisions.

In another embodiment, the step of identifying activities that will aid the organization in achieving improved communication and interaction further includes identifying activities that will improve communication and interaction on safety related issues in the organization.

In another embodiment, the step of identifying activities that will aid the organization in achieving the improved communications and interaction includes identifying activities that will aid the organization in improving communication and interaction on one or more of quality-related issues, productivity-related issues, achievement related issues, customer satisfaction related issues, participant satisfaction related issues, as well as other issues known in the art that will aid in improving communication in an organization.

The progress of the competition, the teams' current standing in the competition, and individual levels of participation may be tracked with the use of a computer-aided tracking system. In one embodiment, the computer-aided tracking system is an internet-based software package. In another embodiment, the computer-aided tracking system is a packaged software system. Additionally, the progress of the competition may be tracked with the use of a paper-based tracking system, and/or a combination of one or more of the described tracking systems and other tracking systems known in the art.

In another aspect, the invention is an interactive system for fostering participant engagement in an organization's efforts to meet stated objectives. The system comprises a platform for organizing and tracking the progress of a method of fostering participant engagement. The method includes identifying objectives to be met within an organization, identifying activities that will aid the organization in meeting the objectives, and assigning point values to the identified activities. The method further includes determining a number of teams to participate, assigning members to each team from among participants in the organization, and conducting a competition among the teams for a predetermined time period, wherein each team is awarded points based on the team's success in completing the identified activities.

### EXAMPLES

For ease of description, the system is described with reference to a platform organized along the format of a professional football league. This format, depiction, and description is not meant to be limiting, but representative of one embodiment. The platform is intended to include formats according to a variety of sports leagues, including, but not limited to, professional football leagues, professional basketball leagues, professional baseball leagues, professional hockey leagues, professional soccer leagues, professional automobile racing leagues, college football leagues, college basketball leagues, college baseball leagues, college hockey leagues, and college soccer leagues, as well as other amateur (i.e., high school or club leagues) and professional sports leagues known in the art.

Additionally, the platform is depicted as an internet-based platform. The platform include one or more of an internet-based platform, a packaged software based platform, and a paper-based platform, as well as other platforms known in the art and combinations of these platforms. Accordingly, references to an internet-based platform formatted according to a professional football league are intended to include the other embodiments.

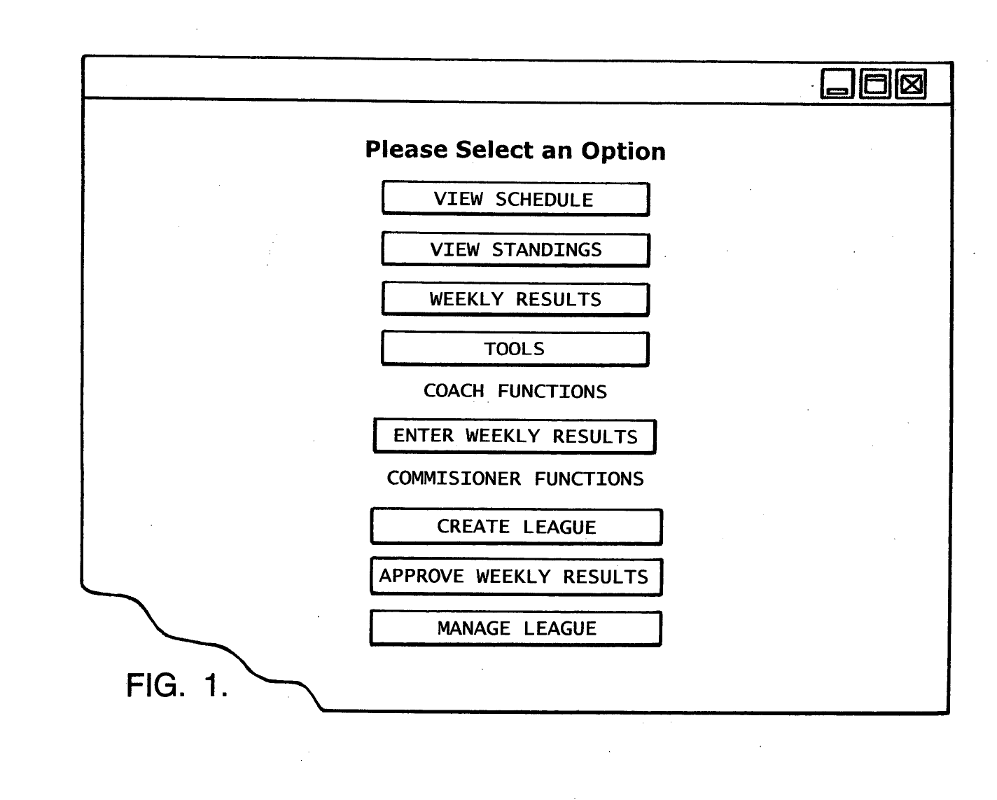

FIG. 1 is a representative depiction of a navigational page for a platform in accordance with the present invention. The depicted navigational page is one page of an internet-based platform. The navigational page includes options such as “view schedule,” “view standings,” “weekly results,” and “tools;” coach functions, such as “enter weekly results;” and commissioner functions, such as “create league,” “approve weekly results,” and “manage league.”

The depicted functions are representative only. It is contemplated that other functions will be included on the navigational page depicted in FIG. 1 as necessary and depending on the league format. The “tools” function may include, but is not limited to, links to a template for conducting a team meeting, links to a template for reporting a safety hazard, as well as other links to activities assigned to the teams. Additionally, different tools may be included based on the particular needs of the organization using the system. The tools function may be a library of templates and activities.

In one embodiment, a platform user would select an appropriate function on the navigational page depicted in FIG. 1 to begin the steps of the present method.

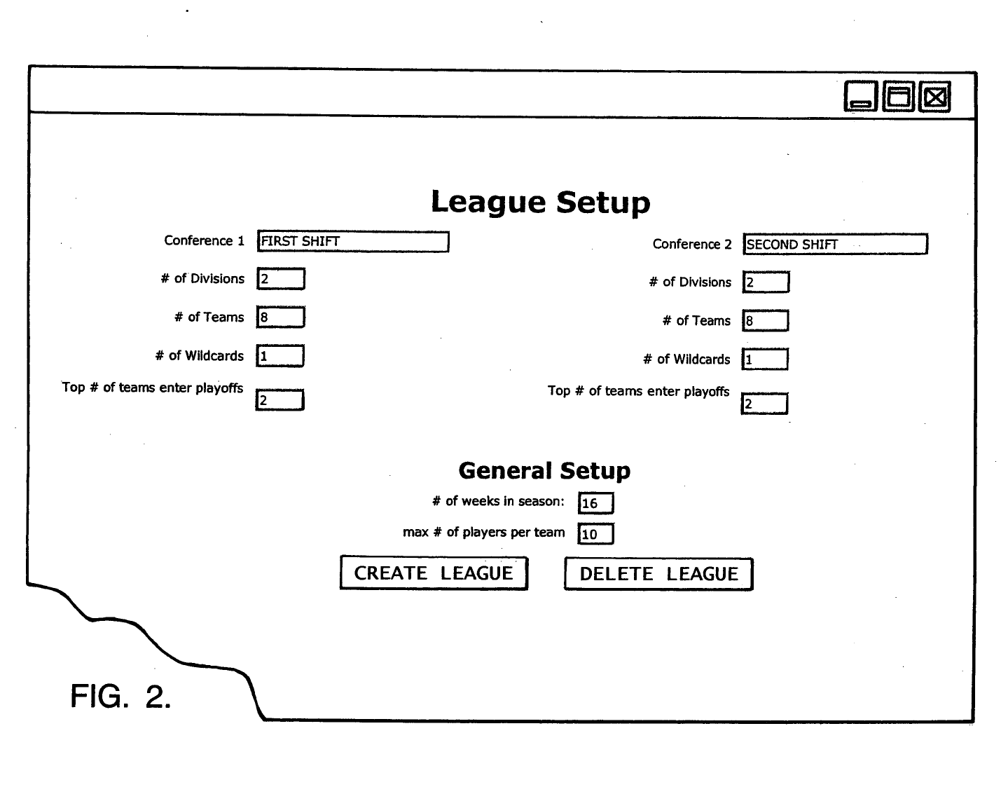

FIG. 2 is a representative depiction of a league setup page for a system in accordance with the present invention. In this representative example, the league is set up by the person organizing the league to include two conferences. Each conference includes two divisions. Each division includes four ten-member teams. The top team from each division is eligible for the playoff portion of the competition. Additionally, one “wildcard” team from each conference is eligible for the playoff portion of the competition. The representative league is set up to have a sixteen week season.

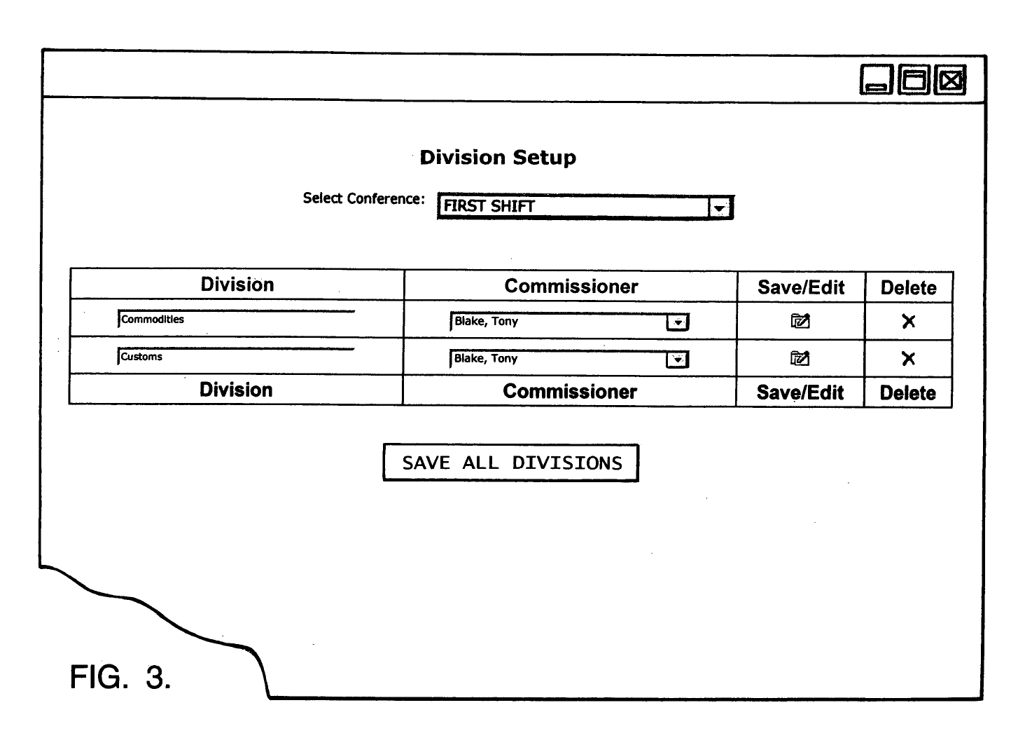

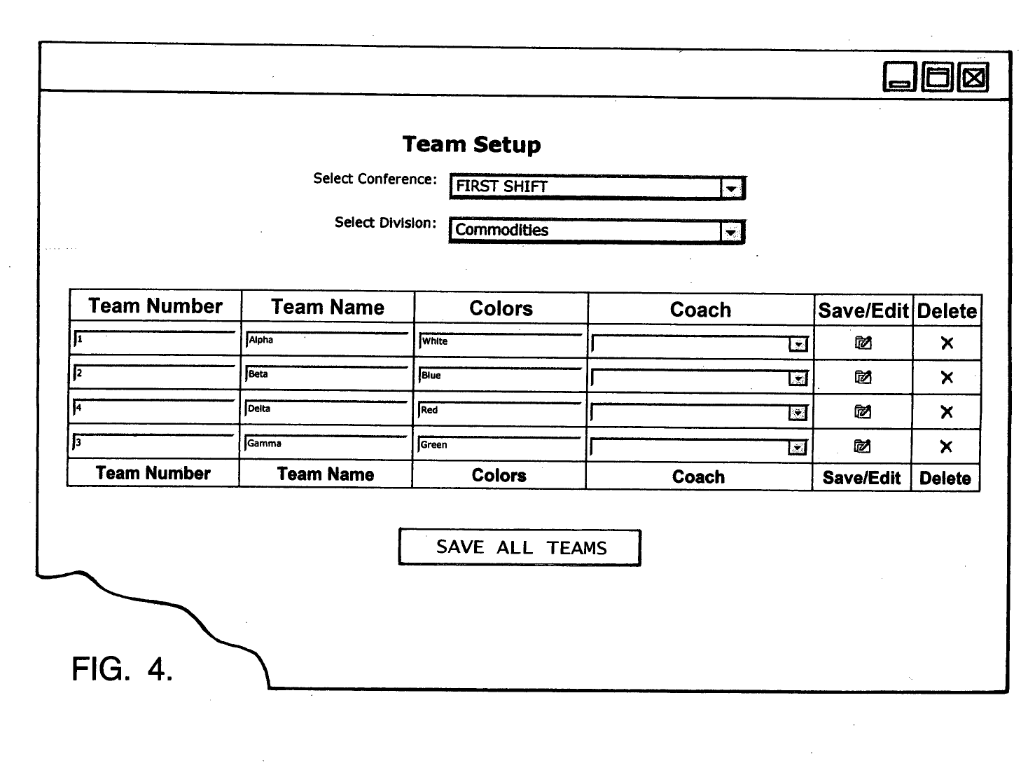

After formation of the league, and as depicted in FIG. 3, formation of each division includes assigning a commissioner to each division. The commissioner for each division, as depicted in FIG. 4, then sets up four teams. Additionally, in this embodiment, either the league organizer or the commissioners may appoint at least one coach for each team.

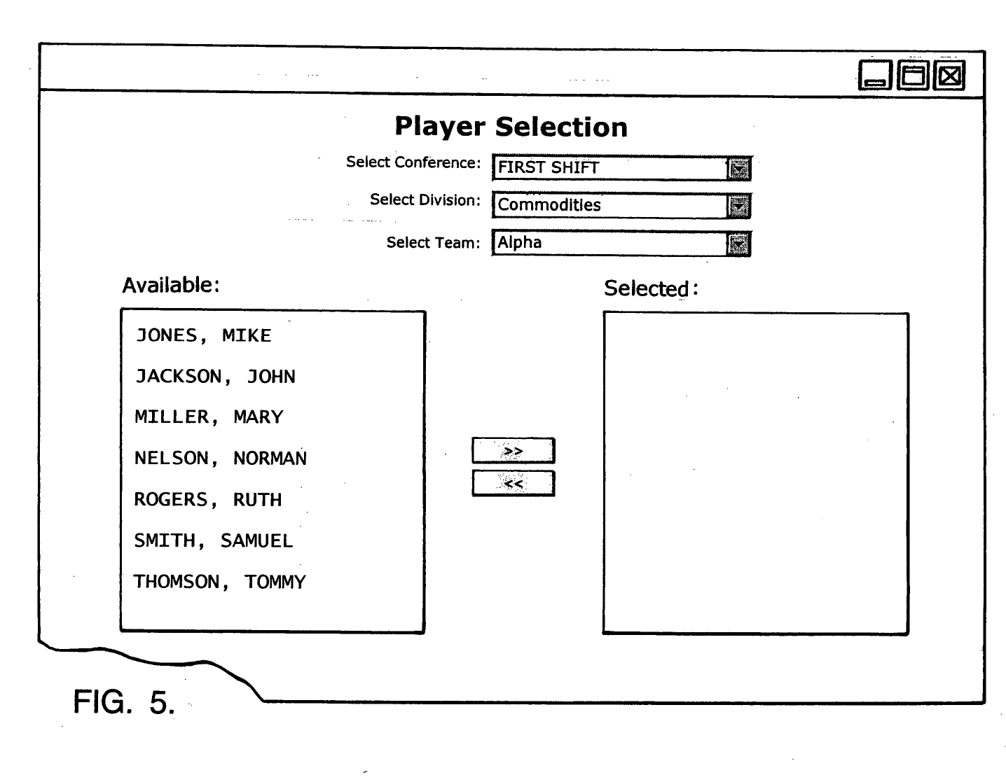

FIG. 5 is a representative depiction of one method of choosing team members in accordance with the present invention. In this embodiment, the coaches, in turn, may select team members according to a draft format.

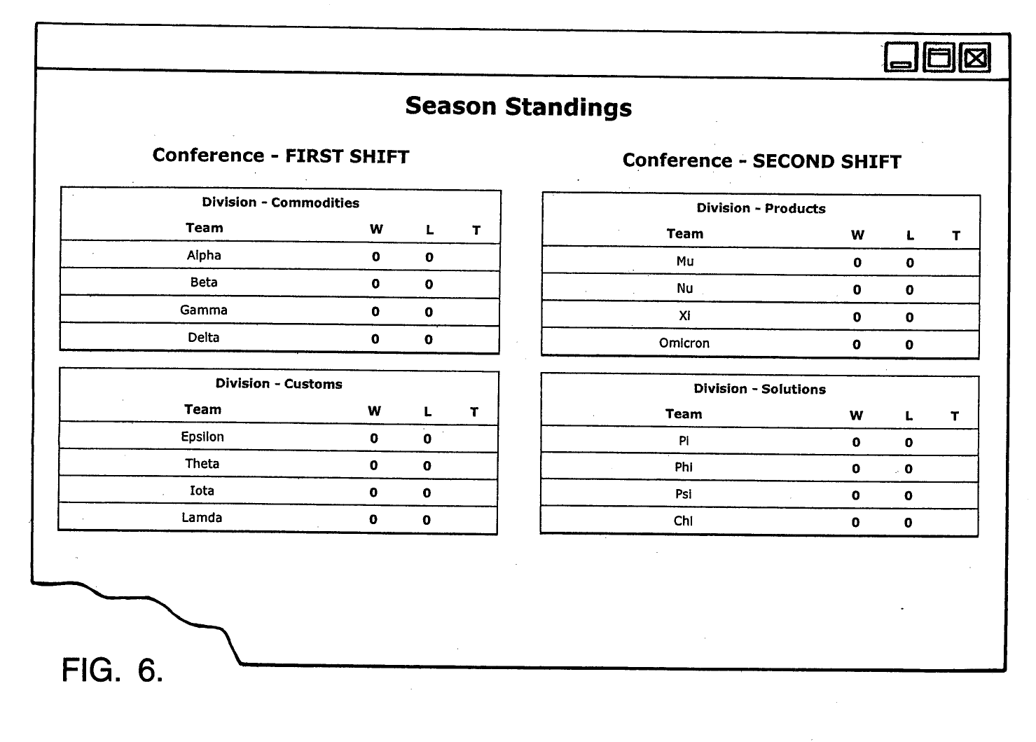

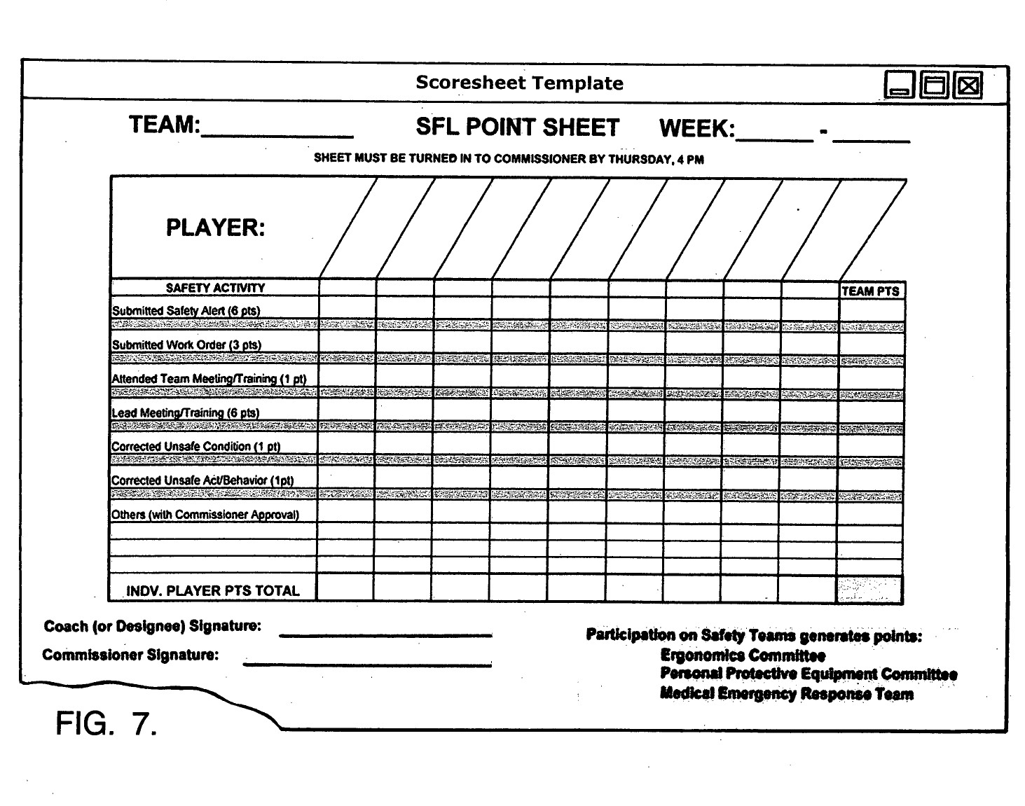

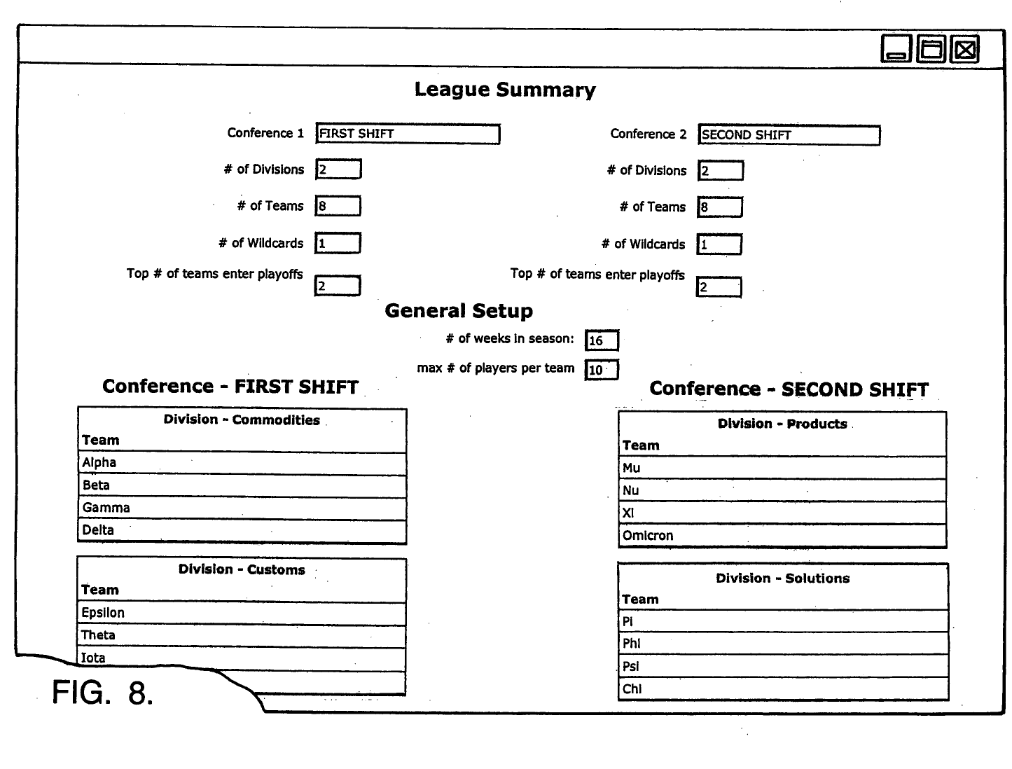

After formation of the teams, a schedule is automatically generated and the competition begins. Each coach or commissioner may then update summaries on a template such as the template depicted in FIG. 6. A representative score sheet, with representative activities identified for a safety organization, is depicted in FIG. 7. FIG. 8 is a representative depiction of a summary page for a league formed in accordance with the present invention. The summary page depicted in FIG. 8 includes information relating to the setup of the league as well as information relating to the delineation of teams into divisions.

In the specification, drawings, and examples, there have been disclosed typical embodiments of the invention and, although specific terms have been employed, they have been used in a generic and descriptive sense only and not for purposes of limitation, the scope of the invention being set forth in the following claims.

1. A method of fostering engagement in an organization's efforts to meet stated objectives, the method comprising:
identifying objectives to be met;
identifying activities that will aid the organization in meeting the objectives;
assigning point values to the activities;
determining a number of teams to participate;
assigning members to each team from among participants in the organization; and
conducting a competition among the teams for a pre-determined time period, wherein each team is awarded points based on the team's success in completing the identified activities.

2. The method according to claim 1, further including tracking the competition through the use of a computer-aided system.

3. The method according to claim 2, wherein the step of tracking the competition through the use of a computer-aided system comprises tracking the competition through an internet-based application.

4. The method according to claim 1, further comprising appointing a team leader to guide each of the teams in carrying out the activities.

5. The method according to claim 4, wherein the step of assigning members to each team is conducted by the team leaders according to a draft format.

6. The method according to claim 1, wherein the step of assigning members to each team further comprises assigning members from different divisions of the organization to work together on each team.

7. The method according to claim 1, wherein the step of assigning members to each team further comprises assigning members from different levels of the organization to work together on each team.

8. The method according to claim 1, wherein the step of conducting a competition for a pre-determined time period comprises conducting a competition according to the format of a professional athletic season.

9. The method according to claim 1, wherein the step of conducting a competition for a pre-determined time period comprises conducting a competition according to the format of an amateur athletic season

10. The method according to claim 1, wherein the step of conducting a competition for a pre-determined time period comprises conducting a competition according to the format of a basketball league.

11. The method according to claim 1, wherein the step of conducting a competition for a pre-determined time period comprises conducting a competition according to the format of a hockey league.

12. The method according to claim 1, wherein the step of conducting a competition for a pre-determined time period comprises conducting a competition according to the format of a football league.

13. The method according to claim 1, wherein the step of conducting a competition for a pre-determined time period comprises conducting a competition according to the format of a baseball league.

14. The method according to claim 1, wherein the step of conducting a competition for a pre-determined time period comprises conducting a competition according to the format of an automobile racing league.

15. The method according to claim 1, wherein the step of conducting a competition for a pre-determined time period comprises conducting a competition according to the format of a soccer league.

16. The method according to claim 1, wherein the step of assigning point values comprises assigning point values to each identified activity in relation to the activity's importance in aiding the organization in meeting stated goals.

17. The method according to claim 1 wherein the step of determining the number of teams to participate comprises determining the number of teams based on the size of the organization.

18. The method according to claim 1, wherein the step of identifying objectives comprises identifying objectives that would improve safety within the organization.

19. The method according to claim 1, wherein the step of identifying objectives comprises identifying objectives that would improve communication within the organization.

20. The method according to claim 1, wherein the step of identifying objectives comprises identifying objectives that would improve productivity within the organization.

21. The method according to claim 1, wherein the step of identifying objectives comprises identifying objectives that would improve quality control within the organization.

22. The method according to claim 1, wherein the step of identifying objectives comprises identifying objectives that would aid a student in achieving improved grades.

23. The method according to claim 1, wherein the step of conducting a competition further comprises tracking the results of the competition.

24. The method according to claim 1, wherein the step of conducting a competition further comprises periodically posting the standings of the teams.

25. The method according to claim 1, wherein the step of conducting a competition further comprises periodically updating the standings of the teams.

26. The method according to claim 1, wherein the step of conducting a competition further comprises awarding a championship to a winning team at the end of the pre-determined time.

27. A team-based competitive method for fostering participant engagement in an organization, the method comprising:
dividing participants in the organization into a predetermined number of teams; and
conducting a season-long competition among the teams, wherein each team is awarded points for completing a series of activities aimed at helping the organization achieve predetermined objectives, and wherein the season-long competition is formatted according to an athletic season.

28. The method according to claim 27, wherein the organization is selected from one or more of manufacturing organizations, healthcare organizations, educational organizations, restaurants, hotels, sales organizations, quality organizations, safety organizations, and non-profit organizations.

29. The method according to claim 27, wherein the number of teams is determined based on the size of the organization.

30. The method according to claim 27, wherein the awarded points are determined based on the importance of the activity to the organization.

31. The method according to claim 27, wherein the sports season is selected from one or more of a professional football season, a professional basketball season, a professional hockey season, a professional automobile racing season, a professional soccer season, a college football season, a college basketball season, a college hockey season, a high school football season, a high school basketball season, a high school hockey season, and a high school soccer season.

32. The method according to claim 27, further comprising tracking the competition through the use of a computer network.

33. A method of improving communication and communication among the divisions of the organization, the method comprising:
creating teams including members from different divisions of an organization;
identifying activities that will aid the organization in achieving improved communication and interact-ion;
assigning point values to the identified activities; and
conducting a competition between the teams, in which each team is awarded points for completing the identified activities, and wherein the competition is patterned after a sports league.

34. The method according to claim 33, wherein the step of creating teams comprises conducting a draft.

35. The method according to claim 31, wherein the step of creating teams including members from different divisions of an organization comprises creating teams from different divisions of an organization selected from one or more of a manufacturing organization, an educational organization, a quality organization, a safety organization, a healthcare organization, a corporate organization, a hotel, a restaurant, a sales organization and a non-profit organization.

36. The method according to claim 33, wherein the step of identifying activities that will improve communication and interaction further includes identifying activities that will improve safety in the organization.

37. The method according to claim 33, wherein the step of assigning point values to the identified activities comprises assigning point values based on the relative importance of the activity to the organization.

38. The method according to claim 33, further comprising tracking the progress of the competition with a computer-aided tracking system.

39. The method according to claim 38, wherein the step of tracking the progress of the competition with a computer-aided tracking system comprises tracking the competition through the use of an internet based software package.

40. An interactive system for fostering participant engagement in an organization's efforts to meet stated objectives, the system comprising a platform for organizing and tracking the progress of a method of fostering participant engagement, the method including:
identifying objectives to be met within the organization;
identifying activities that will aid the organization in meeting the objectives;
assigning point values to the activities;
determining a number of teams to participate;
assigning members to each team from among participants in the organization; and
conducting a competition among the teams for a pre-determined time period, wherein each team is awarded points based on the team's success in completing the identified activities.
